(19) United States
(12) Patent Application Publication
(10) Pub. No.: US 2017/0090805 A1
(43) Pub. Date: Mar. 30, 2017

(54) WORK PARAMETER OF HARD DISK MODIFYING SYSTEM AND MODIFYING METHOD

(71) Applicant: HON HAI PRECISION INDUSTRY CO., LTD., New Taipei (TW)

(72) Inventor: YI-HSIEN LIN, New Taipei (TW)

(21) Appl. No.: 14/918,803

(22) Filed: Oct. 21, 2015

(30) Foreign Application Priority Data
Sep. 29, 2015 (CN) 201510631788.0

(51) Int. Cl. G06F 3/06

(52) U.S. Cl. CPC G06F 3/0629; G06F 3/0617; G06F 3/067

(57) ABSTRACT

A hard disk modifying system includes a hard disk, a driver chip, a displaying module, an input module, a working parameters obtaining module, and a working parameters modifying module. The driver chip connects to the hard disk. The driver chip has a hard disk driver program written thereon. The hard disk driver program includes working parameters of the hard disk. The displaying module displays a working parameters setting interface. The input module allows operator to input working parameters in the working parameters setting interface. The working parameters obtaining module obtains the input working parameters and the working parameters modifying module accordingly modifies the original working parameters in the hard disk driver program. A hard disk modifying method is also disclosed.

### CROSS-REFERENCE TO RELATED APPLICATIONS

This application claims priority to Chinese Patent Application No. 201510631788.0, filed on Sep. 29, 2015, the contents of which are incorporated by reference herein.

### FIELD

The subject matter herein relates to controlling one or more hard disks.

### BACKGROUND

Generally servers include a number of hard disks to store masses of data. Thus, whether the hard disk can work steadily is crucial to the server. In order to obtain working parameters of the hard disk, a programmer programs a driver chip in a basic input/output system and must then test whether the hard disk can work steadily. If the hard disk can not work steadily, the programmer must reprogram the server.

### BRIEF DESCRIPTION OF THE DRAWINGS

Implementations of the present technology will now be described, by way of example only, with reference to the attached figures.

FIG. 1 is a block diagram of a hard disk modifying system.

FIG. 2 is a flowchart of a hard disk modifying method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

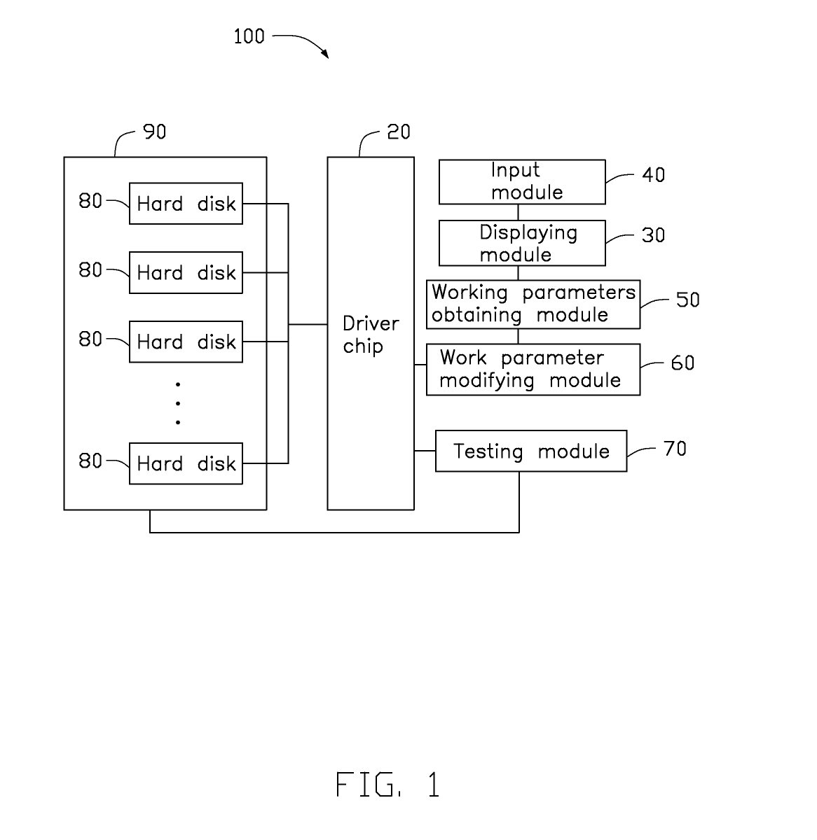

FIG. 1 illustrates a hard disk modifying system 100 in relation to its working parameters. The hard disk modifying system 100 includes a driver chip 20, a displaying module 30, an input module 40, a working parameters obtaining module 50, a working parameters modifying module 60, and a testing module 70. The driver chip 20 connects to at least one hard disk 80. The system 100 is configured to apply to a computer to set working parameters of the hard disk 80.

In the illustrated embodiment, the driver chip 20 connects to a number of hard disks 80. The hard disks 80 are installed in a server 90. The hard disk 80 has a SATA interface through which the driver chip 20 is connected.

When the computer is turned on, the displaying module 30 displays a working parameters setting interface. An operator can set working parameters of each hard disk 80. The working parameters include an input voltage of the hard disk 80. The operator can input the working parameters of the hard disk 80 in the working parameters setting interface through the input module 40. The working parameters obtaining module 50 obtains the working parameters input into working parameters setting interface.

A hard disk driver program is written in the driver chip 20. The hard disk driver program includes the working parameters of the hard disk. The module 60 modifies the original working parameters in the hard disk driver program to the obtained working parameters. The driver chip 20 drives the hard disk 80 according to the modifications. The testing module 70 tests whether the hard disk 80 can work steadily.

The displaying module 30 further displays a test result. When the hard disk 80 does not work steadily in the modified parameters, the displaying module 30 displays which hard disk does not work steadily, to remind the operator to adjust the working parameters of that hard disk.

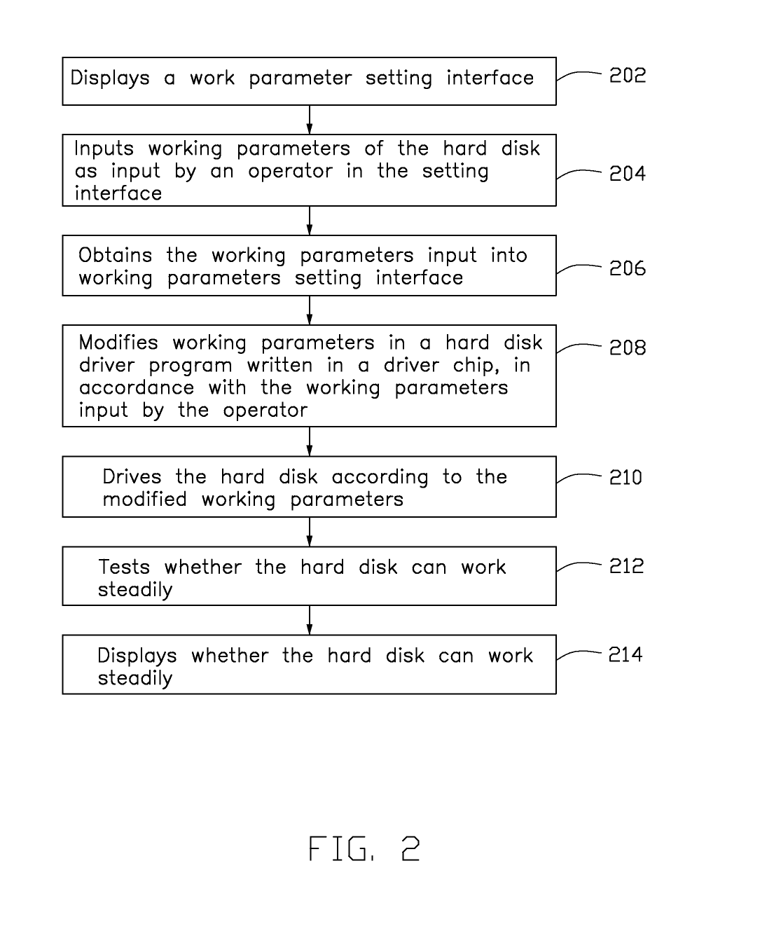

FIG. 2 illustrates a flowchart of a hard disk modification method. The method is applied to a computer to modify working parameters of at least one hard disk 80. The illustrated order of blocks in FIG. 2 is illustrative only and the order of the blocks can change. Additional blocks can be added or fewer blocks may be utilized, without departing from this disclosure. The example method can begin at block 202.

At block 202, the displaying module 30 displays a working parameters setting interface.

At block 204, the input module 40 inputs working parameters of the hard disk 80 as input by an operator in the setting interface.

At block 206, the module 50 obtains the working parameters input into working parameters setting interface.

At block 208, the module 60 modifies working parameters in a hard disk driver program written in a driver chip 20, in accordance with the working parameters input by the operator.

At block 210, the driver chip 20 drives the hard disk 80 according to the modified working parameters.

At block 212, the testing module 70 tests whether the hard disk 80 can work steadily.

At block 214, the displaying module 30 displays whether the hard disk 80 can work steadily.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including, the full extent established by the broad general meaning of the terms used in the claims.

What is claimed is:

1. A hard disk modifying system comprising:
a hard disk;
a driver chip connected to the hard disk, the driver chip having a hard disk driver program written thereon, the hard disk driver program comprises working parameters of the hard disk and contains instructions to cause the chip to:
display a working parameters setting interface;
input working parameters through the working parameters setting interface by an operator;
obtain the working parameters input into the working parameters setting interface; and
modify the original working parameters in the hard disk driver program to be the obtained working parameters.

2. The hard disk modifying system as claimed in claim 1, wherein the hard disk has a SATA interface through which the driver chip is connected.

3. The hard disk modifying system as claimed in claim 1, wherein the driver chip further contains construction to cause the chip to :test whether the hard disk can work steadily.

4. The hard disk modifying system as claimed in claim 3, wherein the driver chip further contains construction to cause the chip to display a test result.

5. The hard disk modifying system as claimed in claim 1, wherein the working parameters comprises an input voltage of the hard disk.

6. The hard disk modifying system as claimed in claim 1, wherein the driver chip drives the hard disk according to the modified work parameter.

7. A hard disk modifying system comprising:
a plurality of hard disk;
a driver chip connected to the hard disks, the hard disks are installed in a server, the driver chip having a hard disk driver program written thereon, the hard disk driver program comprises working parameters of all the hard disks;
a displaying module configured to display a working parameters setting interface;
an input module configured to input working parameters through working parameters setting interface by an operator;
a working parameters obtaining module configured to obtain the working parameters input into the working parameters setting interface; and
a working parameters modifying module configured to modify the original working parameters in the hard disk driver program to be the obtained working parameters.

8. The hard disk modifying system as claimed in claim 7, wherein the hard disk has a SATA interface through which the driver chip is connected.

9. The hard disk modifying system as claimed in claim 7, further comprising:
a testing module configured to test whether the hard disk can work steadily.

10. The hard disk modifying system as claimed in claim 9, wherein the displaying module further display a test result.

11. The hard disk modifying system as claimed in claim 10, wherein the displaying module displays which hard disk can not work steadily.

12. The hard disk modifying system as claimed in claim 7, wherein the working parameters comprises an input voltage of the hard disk.

13. The hard disk modifying system as claimed in claim 7, wherein the driver chip drives the hard disk according to the modified working parameters.

14. A hard disk modifying method comprising:
displaying a working parameters setting interface;
inputting working parameters of a hard disk through the working parameters setting interface;
obtaining the working parameters input into the working parameters setting interface;
modifying the original working parameters in a hard disk driver program written in a driver chip connected to the hard disk to be the obtained working parameters.

15. The hard disk modifying method as claimed in claim 14, further comprising:
driving the hard disk according to the modified working parameters.

16. The hard disk modifying method as claimed in claim 15, further comprising:
testing whether the hard disk can work steadily.

17. The hard disk modifying method as claimed in claim 16, further comprising:
displaying whether the hard disk can work steadily.

18. The hard disk modifying method as claimed in claim 14, wherein the working parameters comprises an input voltage of the hard disk.
